(19) United States
(12) Patent Application Publication
(10) Pub. No.: US 2004/0030594 A1
(43) Pub. Date: Feb. 12, 2004

(54) Method and apparatus for compensating a recipient that participates in a marketing communication

(76) Inventor: Stephen C. Berczik, New Milford, NJ (US)

Correspondence Address: Ryan, Mason & Lewis, LLP, 1300 Post Road, Suite 205, Fairfield, CT, 06430, US

(21) Appl. No.: 10/216,477

(22) Filed: Aug. 8, 2002

(51) Int. Cl. G06F 17/60

(52) U.S. Cl. 705/14; 379/114.1; 379/114.13

(57) ABSTRACT

A method and apparatus are disclosed for compensating a recipient for participating in a marketing communication. The recipient may be compensated by means of a credit applied to his or her existing bill from the corresponding service provider, or by means of a credit applied to a third party account, such as a credit card account of the recipient or a charity that has been designated by the called party to receive such credits. The recipient is notified that he or she may be compensated for a given telemarketing call or another marketing promotion by means of a distinctive telephone ring or a similar distinctive feature. A service provider can also offer a service to its subscribers that employs the distinctive ringing feature described herein to indicate to the customer that a given telephone call is coming from a telemarketer.

### FIELD OF THE INVENTION

The present invention relates generally to marketing systems and, more particularly, to a method and apparatus for compensating a recipient that participates in a marketing communication, such as answering a telephone call from a telemarketer.

### BACKGROUND OF THE INVENTION

Many businesses attempt to attract new customers with various direct marketing approaches, such as a telemarketing promotion. Typically, businesses identify potential customers for a marketing promotion, for example, by analyzing consumer credit histories or purchase histories, or by analyzing socio-economic statistics associated with various geographic locations. Once potential customers are identified, a business will often send one or more solicitations to each potential customer, for example, by mail or telephone. In today's marketplace, however, consumers are constantly inundated with direct mail and telephone calls associated with various marketing promotions.

While many businesses have successfully obtained new customers with such direct marketing approaches, the vast majority of consumers ignore such promotions, in view of the large number of received promotions. In addition, since many consumers tend to be home only in the late evening (and calling rates generally are lower in the evening), telemarketers generally call consumers around dinnertime, which many consumers find to be inconvenient or even annoying. Thus, many consumers will not answer a telephone call if it is known to be from a telemarketer, or will hang up quickly as soon they realize that a telephone call is associated with a telemarketing promotion. In addition, many states maintain a “don't call list” that prevents telemarketers from calling identified state residents who have previously indicated that they do not wish to receive telemarketing calls.

Thus, in order to reach new customers, telemarketers need to motivate potential customers to participate in a marketing communication, for example, by answering a telemarketing call. A need therefore exists for a method and apparatus that compensates a recipient for participating in a marketing communication, such as answering a telephone call from a telemarketer or clicking on a banner advertisement on a web site.

### SUMMARY OF THE INVENTION

Generally, a method and apparatus are disclosed for compensating a recipient for participating in a marketing communication, such as answering a telephone call from a telemarketer or clicking on a banner or pop-up advertisement provided by an online marketer. In an exemplary telemarketing embodiment, the called party is compensated for answering a telephone call associated with a telemarketing promotion. The called party may be compensated by means of a credit applied to his or her existing telephone bill. In the case of online and interactive television marketing promotions, the recipient may be compensated by means of a credit applied to the bill from the corresponding service provider. In addition, the called party may be compensated by means of a credit applied to third party accounts, such as a credit card account of the called party or a charity that has been designated by the called party to receive such credits.

According to another feature of the invention, the recipient is notified that he or she may be compensated for a given telemarketing call or another marketing promotion by means of a distinctive telephone ring or a similar distinctive feature. Currently, a number of local exchange carriers offer a distinctive ringing service to customers. The distinctive ringing service is currently used when a customer has a number of different telephone numbers for a single line and allows a different ringing pattern for each telephone number so that a customer can distinguish which telephone number is ringing. The present invention proposes to use this existing distinctive ringing feature to provide an indication to a customer that the customer will be compensate for answering a telephone call having a distinctive ring, provided any additional conditions are satisfied. The additional conditions may include, for example, a minimum participation time.

According to a further feature of the invention, a service provider, such as a local exchange carrier, can offer a service to its subscribers for an additional charge that employs the distinctive ringing feature described herein anytime a telemarketer is calling the customer. Thus, the distinctive ring provides an indication to the customer that a given telephone call is coming from a telemarketer. It is noted that this feature of the invention is independent of the compensation scheme described above, and the distinctive ringing feature may not necessarily suggest that the customer will be compensated for answering the call.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary network environment in which the present invention can operate;

FIG. 2 is a schematic block diagram of an exemplary call center processor incorporating features of the present invention;

FIG. 3 is a schematic block diagram of an exemplary central office switch incorporating features of the present invention;

FIG. 4 is a flow chart describing an exemplary implementation of the outgoing call process implemented by the call center processor of FIG. 2; and

FIG. 5 is a flow chart describing an exemplary implementation of the telemarketer subsidized phone process implemented by the central office switch of FIG. 3.

### DETAILED DESCRIPTION

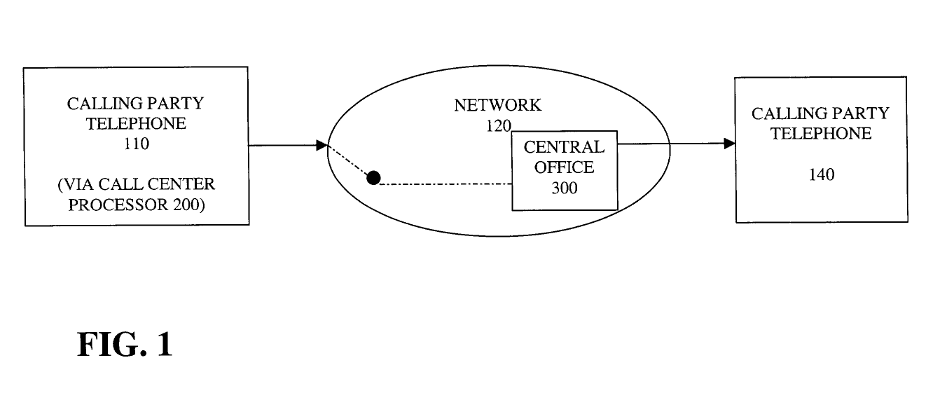

FIG. 1 illustrates an exemplary network environment in which the present invention can operate. As shown in FIG. 1, a calling party 110 contacts a called party 140 over a network 120, such as the Public Switched Telephone Network (PSTN) or the Internet. The calling party 110 contacts the called party 140 in conjunction with a marketing communication, such as a telemarketing promotion, and the called party 140 will be compensated for participating in the marketing communication in accordance with the present invention. While the exemplary embodiment is described herein in the context of a telemarketing promotion presented over a conventional telephone network, the present invention also applies to marketing promotions presented to a party over a packet telephony system, such as a Voice Over IP (VoIP) communication, an interactive television system, such as a digital satellite service, or a data network, such as the Internet.

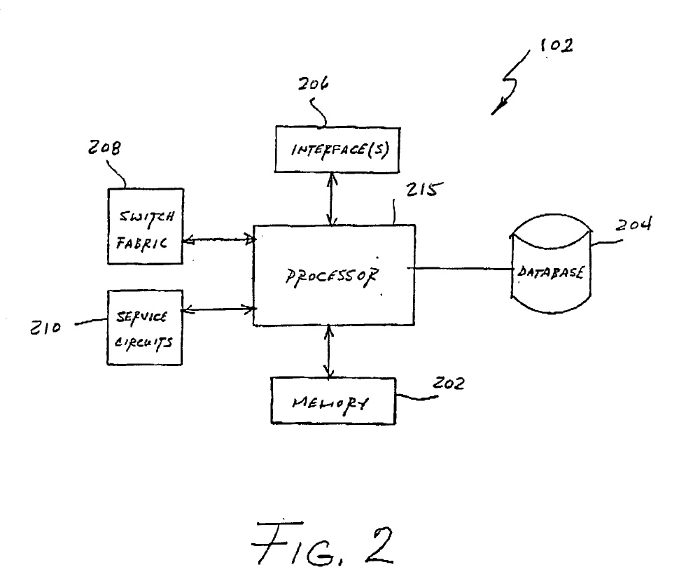

The calling party 110 is typically associated with a telemarketer or a calling center that employs a call center processor 200, discussed below in conjunction with FIG. 2, to process the outgoing telemarketing calls. The call center processor 200 may be embodied as an otherwise conventional DEFINITY® Enterprise Communication Service (ECS) communication system switch available from Avaya Inc. of Basking Ridge, N.J., USA, as modified herein to provide the features and functions of the present invention. Other types of known switches may be used. The conventional aspects of such switches are well known in the art and therefore are not described in detail herein.

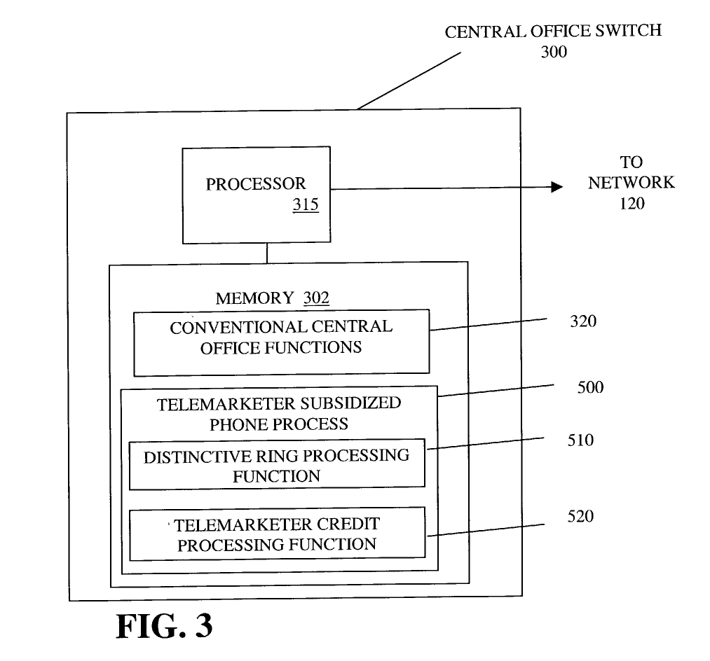

The network 120 may be comprised of various known network elements provided by one or more service providers, such as local exchange carries (LECs) and interexchange carriers (IXCs), often referred to as long distance carriers, as would be apparent to a person of ordinary skill in the art. For illustration purposes, the features and functions of the present invention that are performed within the network 120 are illustrated as being performed by an exemplary central office switch 300, discussed below in conjunction with FIG. 3. It is noted, however, that the features and functions of the present invention that are performed by the exemplary central office switch 300 may be distributed among a number of network elements within the network 120. The central office switch 300 may be embodied as an otherwise conventional central office switch that is well known to those in the art, as modified herein to provide the features and functions of the present invention.

According to one aspect of the invention, the called party 140 is compensated for participating in the marketing communication. In the case of a telemarketing promotion, the called party 140 may be compensated, for example, by means of a credit applied to his or her telephone bill. Generally, the called party 140 will have an account with the local exchange carrier (local telephone service provider) that operates the central office switch 300 and the present invention contemplates providing a credit on the customer's telephone bill. In the case of online marketing promotions, such as electronic mail messages, banner advertisements or “pop up” advertisements, the called party 140 may be compensated, for example, by means of a credit applied to the bill from the Internet Service Provider (ISP) of the called party 140. In the case of a marketing promotion presented by means of an Interactive television advertisement, the called party 140 may be compensated, for example, by means of a credit applied to the bill from the Interactive television service provider of the called party 140. In further variations, the called party 140 may be compensated, for example, by means of a credit applied to third party accounts, such as a credit card account of the called party 140 or a charity that has been designated by the called party 140 to receive such credits.

According to another aspect of the invention, the called party 140 is notified that he or she may be compensated for a given telemarketing call or another marketing promotion, by means of a distinctive telephone ring. Currently, local exchange carriers provide a distinctive ringing service to customers in which the local exchange carrier provides a number of different telephone numbers for a single line for an additional nominal fee. Each of the telephone numbers can be configured to ring with a different ringing pattern so that a customer can distinguish which telephone number is ringing. Various local exchange carriers market this service under different names, including Custom Ringing, IdentaRing, RingMaster, Ringmate, Multi Ring, Personalized Ringing, and Smart Ring.

The present invention proposes a new purpose for this existing distinctive ringing feature. Namely, the present invention proposes that the distinctive ringing feature can provide an indication to a customer that if the customer answers a telephone call having a distinctive ring, that the customer will be compensated for the call, provided any additional conditions are satisfied. The additional conditions may include, for example, a minimum participation time. The minimum participation time may be predefined, and indicated, for example, to potential customers by means of (i) a marketing campaign that educates the public of the proposed telemarketing compensation scheme, (ii) a statement at the start of the call, or (iii) a boop tone that chimes to the customer once the minimum participation time has been exceeded.

As previously indicated, the calling party 110 employs a call center processor 200, shown in FIG. 2. The call center processor 200 processes outgoing telemarketing calls to one or more called parties 140. FIG. 2 is a schematic block diagram of an exemplary call center processor 200 incorporating features of the present invention. The call center processor 200 may be connected to one or more external endpoints, e.g., external terminals or system processing elements, via a network (not shown) or other suitable communication channel(s).

As shown in FIG. 2, the exemplary call center processor 200 includes a processor 215, a memory 202, a database 204, one or more interfaces 206, a switch fabric 208, and a set of service circuits 210. The processor 215 may be implemented as a central processing unit (CPU), microprocessor, application-specific integrated circuit (ASIC) or other type of digital data processor, as well as various portions or combinations of such elements. The memory 202 may be a random access memory (RAM), a read-only memory (ROM) or combinations of these and other types of electronic memory devices.

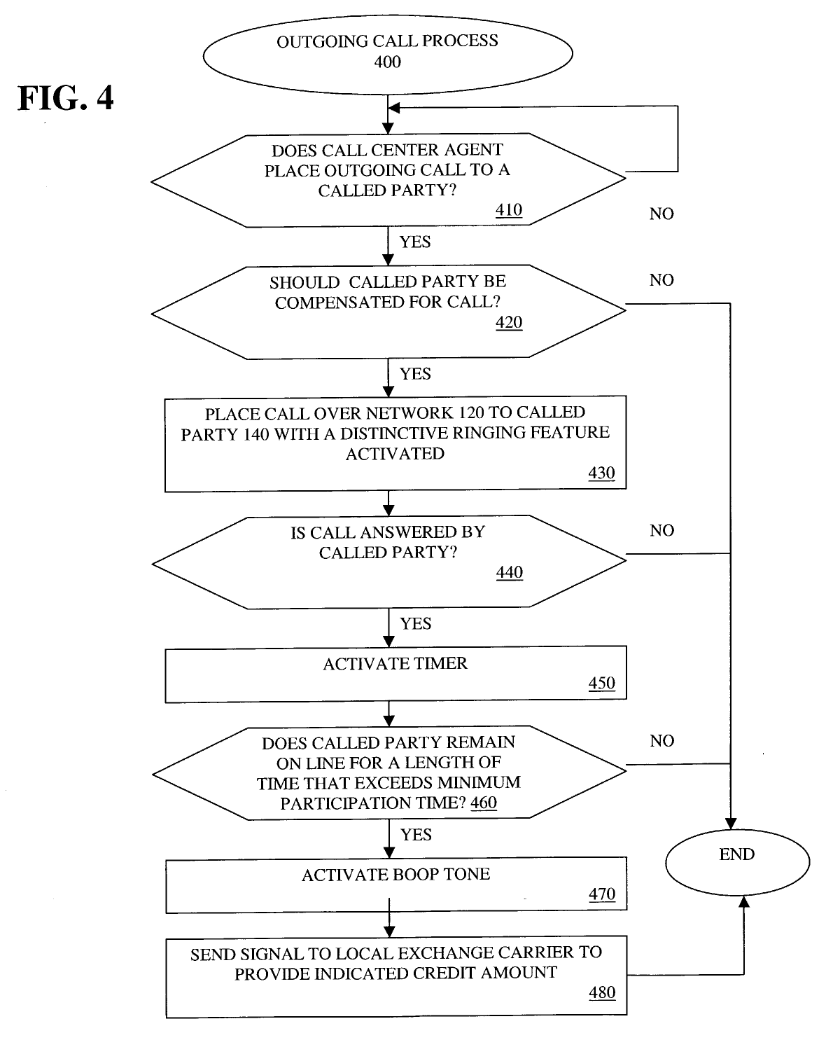

The processor 215 operating in conjunction with the memory 202 executes one or more software programs for providing script processing and other functions within the call center processor 200. Such programs may be stored in memory 202 or another storage device accessible to the call center processor 200 and executed by processor 215 in a conventional manner. For example, as discussed below in conjunction with FIG. 4, the memory 202 may store an outgoing call process 400 that compensates called parties 140 for answering telemarketing calls in accordance with the present invention.

The database 204 may be, e.g., an optical or magnetic disk-based storage device, or other conventional storage device associated with or otherwise accessible to the call center processor 200. The database 204 may be used to store, e.g., feature assignments to particular feature buttons or codes, directory number assignments to corresponding call appearances or direct facility termination keys, access restrictions, and other administrative information regarding the configuration of the system, as well as other types of information. The service circuits 210 may include tone generators, announcement circuits, etc. These circuits and the interfaces 206 are controlled by processor 215 in implementing call processing functions in the call center processor 200.

The call center processor 200 may include additional elements that are omitted from FIG. 2 for simplicity and clarity of illustration. For example, the call center processor 200 may include a port card for each type of user terminal associated therewith. In addition, it will be appreciated by those skilled in the art that the call center processor 200 may be configured to support multiple user terminals of different types, e.g., wired deskset terminals, wireless deskset terminals, personal computers, video telephones or other advanced terminals, etc. Also associated with the call center processor 200 may be an administrator terminal (not shown) that is used to program the operation of the call center processor 200 during a system administration, e.g., an initial set-up and configuration of the system or a subsequent system-level or user-level reconfiguration. Other devices not shown in the figures may be associated with the call center processor 200, such as an adjunct feature server. Such an adjunct may be physically incorporated within the switch, and may be partially or completely implemented using other switch elements such as processor 215 and memory 202.

As previously indicated, an exemplary central office switch 300 performs the features and functions of the present invention that are performed within the network 120. FIG. 3 is a schematic block diagram of an exemplary central office switch 300 incorporating features of the present invention. The conventional aspects of such a central office switch 300 are well known in the art and therefore are omitted from FIG. 3. As shown in FIG. 3, a call center processor 300 in accordance with the present invention includes a processor 315 and a memory 302, in addition to other conventional elements (not shown) that provide switching and interface functions.

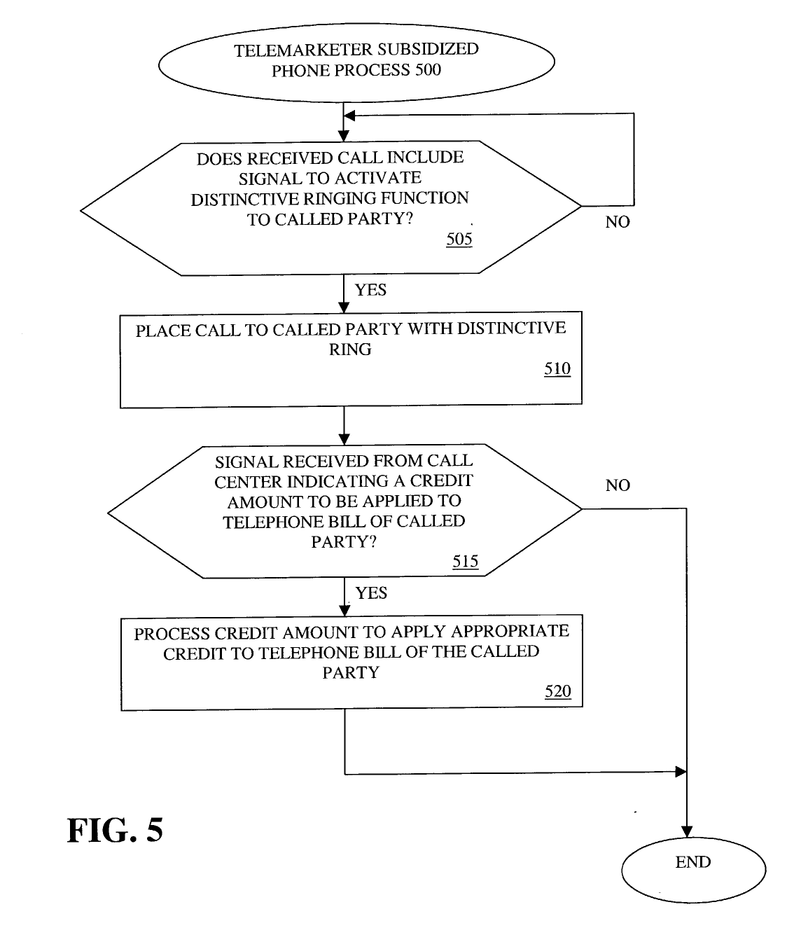

The processor 315 operating in conjunction with the memory 302 executes one or more software programs for providing call processing and other functions within the central office switch 300. Such programs may be stored in memory 302 or another storage device accessible to the central office switch 300 and executed by processor 315 in a conventional manner. For example, as discussed below in conjunction with FIG. 5, the memory 302 may store a telemarketer subsidized phone process 500 that compensates called parties 140 for answering telemarketing calls in accordance with the present invention. Among other functions, the telemarketer subsidized phone process 500 includes a distinctive ring processing function 510 and a telemarketer credit processing function 520.

As previously indicated, the call center processor 200 implements an outgoing call process 400, shown in FIG. 4, that compensates called parties 140 for answering telemarketing calls in accordance with the present invention. FIG. 4 is a flow chart describing an exemplary implementation of the outgoing call process 400. As shown in FIG. 4, the outgoing call process 400 is initiated during step 410 when a call center agent places an outgoing call to a called party 140 in conjunction with a telemarketing promotion. Before the call is placed, a test is performed during step 420 to determine if the called party 140 should be compensated for receiving the call. For example, this determination may be made by prompting the call center agent, or by accessing a data record associated with a given telemarketing promotion.

If it is determined during step 420 that the called party 140 will not be compensated for receiving the call, then execution of the outgoing call process 400 terminates and the call is handled in a conventional manner. If, however, it is determined during step 420 that the called party 140 will be compensated for receiving the call, then the call is placed over the network 120 during step 430 to the called party 140 with a distinctive ringing feature activated. It is noted that the calling party 110 may activate the distinctive ringing feature, for example, on a per-call basis by complying with the signaling requirements of a given local exchange carrier or by dialing a dedicated access number for such calls. If the call is answered by the called party 140 during step 440, then a timer is activated during step 450.

If it is determined during step 460 that the called party 140 remains on the telephone line for a length of time that exceeds a minimum participation time, then a boop tone is sent to the called party 140 during step 470 to indicate that the compensation requirements have been satisfied and a signal is sent to the local exchange carrier during step 480 to provide the indicated credit amount to the telephone bill of the called party 140. Thereafter, the remainder of the telephone call is processed in a conventional manner and the outgoing call process 400 terminates.

As previously indicated, the central office switch 300 implements a telemarketer subsidized phone process 500, shown in FIG. 5, that processes a telemarketing call in accordance with the compensation scheme of the present invention. FIG. 5 is a flow chart describing an exemplary implementation of the telemarketer subsidized phone process 500. As shown in FIG. 5, the telemarketer subsidized phone process 500 is initiated during step 510 when a call is received, for example, from a telemarketer in conjunction with a telemarketing promotion. The telemarketer subsidized phone process 500 includes a distinctive ring processing function 510 and a telemarketer credit processing function 520.

Thus, a test is performed during step 505 to determine if the received call includes a signal to activate the distinctive ringing function to the called party 140. If it is determined during step 505 that the received call does not include a signal to activate the distinctive ringing function, then the call may be processed in a conventional manner and the telemarketer subsidized phone process 500 terminates. If, however, it is determined during step 505 that the received call does include a signal to activate the distinctive ringing function, then the call is placed to the called party 140 with a distinctive ring indicating that the called party 140 will be compensated for answering the call in accordance with the present invention.

Thereafter, the call is processed by the central office switch 300 in a conventional manner, until a signal is received during step 515 from the call center processor 200 indicating a credit amount to be applied to the telephone bill of the called party 140. Once the signal is received from the call center processor 200 with the corresponding credit amount, the telemarketer subsidized phone process 500 processes the credit amount during step 520 to apply an appropriate credit to the telephone bill of the called party 140.

In one exemplary implementation, the telemarketer credit processing function 520 may be implemented using the infrastructure of the MultiQuest 900 switch, commercially available from AT&T Corp. and described, for example, in U.S. Pat. No. 5,187,710, incorporated by reference herein. As initially contemplated, the MultiQuest 900 switch is used by 900 and 976 number service providers to charge a customer who dials a premium service 900 or 976 number. The MultiQuest switch allows the service provider of a 900 number to signal price changes to the AT&T network over a separate channel during a call to the 900-number. As originally contemplated, the MultiQuest switch allows provides the following options: (i) free call (no charge for the entire call); (ii) flat charge (fixed price for call); (iii) establish per minute rate on a per-call basis; (iv) premium charge (a flat charge added to the per minute rate); and (v) premium credit (a flat amount deducted from total price of the call). Thus, conventional applications of the MultiQuest billing features do not allow the total price for a call to go below $0. In other words, the existing MultiQuest billing features have not previously been employed to provide a credit to a called party 140 that compensates the called party 140 for answering a telemarketing call.

In this manner, the called party 140 is compensated for participating in the marketing communication. In the exemplary case of a telemarketing promotion, the called party 140 is compensated by means of a credit applied to his or her telephone bill.

According to a further aspect of the invention, a service provider, such as a local exchange carrier, can offer a service to its subscribers for an additional charge that employs the distinctive ringing feature described above anytime a telemarketer is calling the customer. The service provider can determine that a telemarketer is calling the customer, for example, by means of signaling included with the call or by means of caller identification techniques, as would be apparent to a person of ordinary skill in the art. Thus, a customer will know that a given telephone call is associated with a telemarketing promotion. It is noted that this embodiment of the invention is independent of the telemarketing compensation scheme described above, and the distinctive ringing feature may not necessarily suggest that the customer will be compensated for answering the call.

It is to be understood that the embodiments and variations shown and described herein are merely illustrative of the principles of this invention and that various modifications may be implemented by those skilled in the art without departing from the scope and spirit of the invention.

I claim:

1. A method for compensating a recipient for participating in a marketing communication, said method comprising the steps of:
providing an indication to said recipient that said recipient will be compensated for participating in said marketing communication; and
providing a credit to an account of said recipient if said recipient participates in said marketing communication.

2. The method of claim 1, wherein said indication is a distinctive feature associated with said marketing communication.

3. The method of claim 2, wherein said distinctive feature is a distinctive ringing feature associated with a telemarketing call.

4. The method of claim 1, wherein said credit is a credit to an account maintained with a service provider of said recipient.

5. The method of claim 1, wherein said credit is a credit to a credit card account maintained by said recipient.

6. The method of claim 1, wherein said credit is a credit to a charity designated by said recipient.

7. The method of claim 1, further comprising the step of determining if any additional conditions are satisfied.

8. The method of claim 7, wherein said additional conditions include a minimum participation time.

9. The method of claim 7, further comprising the step of providing an indication to said recipient once any additional conditions are satisfied.

10. The method of claim 9, wherein said indication is a boop tone.

11. The method of claim 9, wherein said marketing communication is a telemarketing call that must be answered by said recipient in order to receive said credit.

12. A method for providing an indication to a called party that an incoming call is from a telemarketer, said method comprising the steps of:
determining that an incoming call is from a telemarketer; and
providing a distinctive ringing feature with said call to indicate to said called party that said incoming call is from a telemarketer.

13. The method of claim 12, wherein said determining step evaluates signaling information received with said incoming call.

14. The method of claim 12, wherein said determining step evaluates caller identification information received with said incoming call.

15. The method of claim 12, further comprising the step of providing a credit to an account of said recipient if said recipient answers said incoming call.

16. A system for compensating a recipient for participating in a marketing communication, said system comprising:
a memory that stores computer-readable code; and
a processor operatively coupled to said memory, said processor configured to implement said computer-readable code, said computer-readable code configured to:
provide an indication to said recipient that said recipient will be compensated for participating in said marketing communication; and
provide a credit to an account of said recipient if said recipient participates in said marketing communication.

17. The system of claim 16, wherein said indication is a distinctive feature associated with said marketing communication.

18. The system of claim 17, wherein said distinctive feature is a distinctive ringing feature associated with a telemarketing call.

19. The system of claim 16, wherein said credit is a credit to an account maintained with a service provider of said recipient.

20. The system of claim 16, wherein said credit is a credit to a credit card account maintained by said recipient.

21. The system of claim 16, wherein said credit is a credit to a charity designated by said recipient.

22. The system of claim 16, wherein said processor is further configured to determine if any additional conditions are satisfied.

23. The system of claim 22, wherein said additional conditions include a minimum participation time.

24. The system of claim 22, wherein said processor is further configured to provide an indication to said recipient once any additional conditions are satisfied.

25. The system of claim 24, wherein said indication is a boop tone.

26. A system for providing an indication to a called party that an incoming call is from a telemarketer, said system comprising:
a memory that stores computer-readable code; and
a processor operatively coupled to said memory, said processor configured to implement said computer-readable code, said computer-readable code configured to:
determine that an incoming call is from a telemarketer; and
provide a distinctive ringing feature with said call to indicate to said called party that said incoming call is from a telemarketer.

27. The system of claim 26, wherein said processor is further configured to evaluate signaling information received with said incoming call.

28. The system of claim 26, wherein said processor is further configured to evaluate caller identification information received with said incoming call.
